(19) United States
(12) Patent Application Publication
(10) Pub. No.: US 2020/0094789 A1
(43) Pub. Date: Mar. 26, 2020

(54) REPAIR KIT FOR AUTOMOTIVE COATINGS, AND METHOD FOR REPAIRING AUTOMOTIVE COATINGS USING THE REPAIR KIT

(71) Applicant: BASF Coatings GmbH, Münster (DE)

(72) Inventor: Cornelis Adrianus Maria Verdaasdonk, Muenster (DE)

(21) Appl. No.: 16/605,882

(22) PCT Filed: Apr. 4, 2018
(86) PCT No.: PCT/EP2018/058540

§ 371 Date: Oct. 17, 2019

(30) Foreign Application Priority Data
Apr. 24, 2017 (EP) 17167706.5

(51) Int. Cl. B60S 5/00; C09D 7/20; B05D 1/28; B05D 1/36; B05D 7/16; B05D 7/00; B05D 3/12; B43K 5/18; B43K 5/02

(52) U.S. Cl. CPC B60S 5/00; C09D 7/20; B05D 1/28; B05D 1/36; B43K 5/02; B05D 7/536; B05D 3/12; B43K 5/1845; B05D 7/16

(57) ABSTRACT

Disclosed is a refinishing kit for automobile paint systems including at least two markers, a reservoir with an opening, a valve which can close and open the reservoir, and a marker tip, where the reservoir includes a coating material. The valve can be reversibly opened by exerting pressure, so that the coating material can be discharged from the reservoir. The marker tip and the valve are connected, such that a pressure exerted on the marker tip is transmitted to the valve and coating material can be conveyed by way of the opening of the valve into the marker tip. Material conveyed into the marker tip can pass through the tip and can be transferred onto an area requiring refinish. One of the markers includes a coating material providing a color and/or a special effect, and the second marker includes a UV-curable clearcoat material.

The present invention relates to a refinishing kit for automobile paint systems and to a process for the refinishing of automobile paint systems with the use of the refinishing kit. The refinishing kit permits achievement of an ideal balance between, on the one hand, efficient refinishing which can be completed speedily and, on the other hand, a refinishing result that is satisfactory, of high quality and durable.

### PRIOR ART

Multicoat paint systems are in principle known in the automobile industry sector, and are generally applied on metallic substrates or else on plastics substrates (in particular in the automobile add-on parts sector).

In the field of painting of metallic substrates, these multicoat paint systems comprise, viewed from the metallic substrate outward, an electrocoat, a coat mostly termed surfacer coat, applied directly to the electrocoat, at least one coat, generally termed basecoat, comprising color pigments and/or special-effect pigments, and a clearcoat. Another possibility that may be encountered, instead of separate basecoat and clearcoat, is a single coat which is then termed colorant topcoat.

Similar paint builds are encountered in the field of plastics substrates, but here by way of example specific primer-surfacers are applied instead of an electrocoat, and the plastics substrate is often pretreated, for example flame-treated, before application of a coating.

The fundamental functions and properties of the various coats are likewise known and do not require any more detailed explanation.

The multicoat paint systems mentioned are exposed to enormous stresses during the correct use of an automobile. In particular at higher velocities, small sharp-edged particles such as small stones or loose chippings are often thrown up by the vehicle or else by preceding vehicles, and impact the coating surface at high relative velocities. A frequent occurrence here is localized removal of coating material extending to relatively deep layers of the multicoat paint system (stone impact). The damaged areas are visually discernible as depressions with altered hue.

Scratches are another typical type of damage to vehicle paint systems. Simply on the basis of statistics, it is highly probable that accidental exposure of the paint system to pressure from sharp-edged and hard objects such as keys, shopping trolleys, watches, etc. will remove coating material. Again, this removal of material extends to relatively deep layers, to an extent determined by sharpness and by pressure exerted. The damaged areas are visually discernible as regions with altered gloss and—in the case of relatively deep damaged areas—altered hue.

A known refinishing solution for the damaged areas described consists in refinishing in appropriate workshops, where a refinishing paint system is applied by experts and with high cost for time and materials. The procedure here is that appropriately complex and software-controlled tools for matching of color and/or of special effects, and/or comparisons of color and/or of special effects by way of color cards (color tool chips) are first used to determine the present color of the surface requiring refinish, a formulation appropriate to this color is read off, and after mixing of the appropriate formulation and any necessary fine adjustment of the formulation (and thus color/special effect) the refinishing is carried out. Items incurring high costs here are not only the large amounts of time and material per se but, of course, also the complex color-matching tools that have to be supplied by the manufacturer of the refinish coating.

On the other hand, there is the possibility of undertaking an appropriate refinish in a very inexpensive and simple manner by way of what are known in the technical jargon as paint sticks. These paint sticks are generally small-volume bottles or containers with screw cap comprising coating material, where the cap has an integrated paint brush which in the closed condition projects into the coating material. Once the paint stick has been opened, the coating material can then be applied by way of the paint brush to the surface requiring refinish. The coating materials here have been matched with a varying degree of precision to the color of the original paint system.

Although this type of refinish can be achieved without involvement of a refinish workshop, it also has clear disadvantages.

Firstly, the use of brush strokes to apply the coating material to the surface requiring refinish in a manner that produces a homogeneous surface requires a degree of skill. In particular, there is the risk of applying excess material which is then difficult to remove. It is also highly probable that curtaining will occur. Secondly, the refinish obtained by way of this refinishing method generally has only very limited advantages both in respect of the perceived color and in relation to the durability of the refinish. Under normal circumstances, the refinished area remains highly visible, even from a large distance. It is almost impossible to achieve a paint result that will last for a prolonged period or is durable, in particular in view of the ongoing effects of weathering.

In various sectors of the automobile industry, for example in the context of the large-scale maintenance operations carried out on automobiles in large fleets (car-hire industry), and also sometimes in the context of the planned sale of automobiles as used vehicles after the end of an appropriate leasing period (de-fleet process), it is not practicable to use the complicated expert approach to carry out appropriate refinishing of paint systems. On the other hand, the very low quality standards of a refinish by way of known paint sticks certainly does not meet the requirements.

There is therefore a need for a refinish solution for automobile paint systems which on the one hand does not require the very time-consuming and expensive steps of expert refinishing, with high materials usage, but on the other hand ensures acceptable quality of the result of refinishing. This is precisely the starting point for the present invention.

### TECHNICAL SOLUTION

A novel refinishing kit for automobile paint systems has been discovered, comprising

(1) at least one cleaner for application to a damaged area requiring refinish in an automobile paint system,

(2) at least one cleaning cloth for take-up of the cleaner from (1) and of any contamination present on the damaged area requiring refinish,

(3) at least one means of roughening of the damaged area requiring refinish and of mechanical removal of loose coating material in and/or at the damaged area,

(4A) and (4B) at least two markers, respectively comprising

(4.1) a reservoir with an opening,

(4.2) a valve which can be placed onto the opening of the reservoir from (4.1), thus closing the opening of the reservoir, and

(4.3) a marker tip,

where

the reservoir comprises a coating material,

the valve can be reversibly opened by exerting pressure, so that the coating material can be discharged from the reservoir,

there is connection between the marker tip and the valve, such that a pressure exerted on the marker tip is transmitted to the valve and coating material can be conveyed by way of the opening of the valve into the marker tip, and

the design of the marker tip is such that coating material conveyed into the marker tip can pass through the tip and can be transferred onto the damaged area requiring refinish,

where moreover the marker (4A) comprises a coating material which provides a color and/or a special effect, and the marker (4B) comprises a UV-curable clearcoat material,

and

(5) at least one means of hardening of the clearcoat material from (4) by irradiation with UV light.

The meaning of the term kit is that the components present in the kit (i.e. in this case the components (1) to (5)) are kept available so that they can be used in appropriate sequence for refinishing; (in this connection see also the process of the invention for the refinishing of automobile paint systems). It is, of course, necessary for this purpose that the components (1) to (5) are stored with a certain degree of spatial closeness to one another. However, it is not necessary that the components are kept available with extreme spatial closeness to one another, for example within an individualized storage unit. However, this is preferred. Accordingly, it is preferable that the components of the kit are stored within an individualized storage unit, for example within a case, and are thus kept available for the use in the refinishing process.

The novel refinish kit is suitable for automobile paint systems, i.e. for refinishing of automobile paint systems. However, it can of course also be used for refinishing of other paint systems.

The novel refinishing kit is provided by the present invention and accordingly is also termed refinishing kit of the invention.

A process has also been discovered for the refinishing of automobile paint systems with the use of the refinishing kit of the invention, comprising the following steps in the stated sequence:

(i) application of the cleaner (1) to a damaged area requiring refinish in an automobile paint system,

(ii) take-up, by way of the cleaning cloth (2), of the cleaner (1) applied and of any contamination present on the damaged area requiring refinish,

(iii) by way of the means (3), roughening of the damaged area requiring refinish and mechanical removal of any loose coating material present in and/or at the damaged area,

(iv A) by way of the marker (4A), application, to the damaged area requiring refinish, of coating material which provides a color and/or a special effect, and air-drying of the coating material applied,

(iv B) by way of the marker (4B), application of UV-curable clearcoat material to the applied coating material which provides a color and/or a special effect,

and

(v) by way of the means (5), hardening of the applied clearcoat material by irradiation with UV light.

The novel process is likewise provided by the present invention, and accordingly is also termed process of the invention.

The refinishing kit of the invention and the process of the invention ensure that resource-efficient refinishing and high-quality refinishing are combined as specifically required in extensive sectors of automobile maintenance operation.

### DESCRIPTION

The refinishing kit of the invention firstly comprises a cleaner (1), also termed cleaning composition. This cleaner can in principle be any cleaner known for this purpose, in particular water-based cleaning compositions based on surfactants, examples therefore being soaps and caustic solutions.

The refinishing kit moreover comprises a cleaning cloth (2). Here again, it is possible to use any means that is known in this context to the person skilled in the art. The cleaning cloth here can comprise, or consist of, any material known for this purpose. Examples that may be mentioned are cotton, linen, and also polyester-, polyacrylic- or polyamide-based synthetic-fiber materials.

The refinishing kit moreover comprises a means (3) of roughening of the damaged area requiring refinish and of mechanical removal of loose coating material in and/or at the damaged area. Specifically, this can be one of the typical abrasive tools having a surface comprising the abrasive agents that are likewise known (flint, quartz, corundum, emery, garnet, in particular corundum). Examples that may be mentioned are abrasive paper or emery paper and polishing sticks. Appropriate polishing sticks are preferably of cylindrical shape, and the diameter of their ends is by way of example from 1 to 3 millimeters, their length being by way of example from 4 to 10 centimeters, with the polishing agent arranged at the rounded ends. The transition from the ends to the curved surface of the cylinder here is generally designed to be gradual or rounded, so that polishing can give an ideal result.

The refinishing kit of the invention likewise comprises at least two markers (4A) and (4B). The markers comprise respectively (4.1) a reservoir with an opening, (4.2) a valve which can be placed onto the opening of the reservoir from (4.1) thus closing the opening of the reservoir, and (4.3) a marker tip.

The reservoir here has by way of example the cylindrical shape known from markers or sticks, where one end is permanently closed and the second end is open and thus can be used to charge coating material. A typical capacity of the reservoir is from 3 to 15 milliliters.

The valve or pressure valve can be located on the opening of the reservoir and thus close said opening. Exertion of pressure can appropriately reversibly open said valve, and coating material can be discharged.

There is connection between the marker tip and the valve, for example by way of a cap sleeve known per se or in the form of part of said sleeve, such that pressure exerted on the tip is transmitted to the valve and coating material is conveyed by way of the opening of the valve into the marker tip. Exertion of pressure on the marker tip is generally achieved by bringing the tip into contact with the damaged area requiring refinish and then pressing the tip manually onto the surface of the damaged area.

The design of the marker tip is such that coating material conveyed into the marker tip can pass through the tip and can be transferred onto the damaged area requiring refinish. To this end, the marker tip has been produced by way of example from foam material or felt material which can absorb, and thus take up, the coating material. The pressing, already described above, of the tip onto the surface of the damaged area then causes transfer of coating material onto the surface to an extent depending on pressure exerted and time for which the pressure is exerted. The tip can be configured with various line thicknesses, as required for the intended use of the marker (refinish of relatively large regions or only small, local regions).

It is preferable that the marker moreover comprises a cap which can be placed on the marker tip and in this condition protectively covers the tip, and preferably also all of the other marker constituents situated outside of the reservoir. Drying-out of the coating material within the tip material or within the marker tip is thus prevented or retarded.

These marker systems are in principle known and are marketed by way of example as text markers or permanent markers in the stationary industry or as a requirement for handicraft work. Because of the coating material in the marker (4B), this material being described in more detail at a later stage below, it is preferable that the marker (4B) is composed of materials impermeable to UV light and/or at least has at least one layer impermeable to UV light, so that the coating material present in the marker cannot be exposed to any UV light. The UV radiation content of daylight is thus prevented from having any influence on the coating material.

The coating material which provides a color and/or a special effect can be one of the coating materials in principle known for this purpose, i.e. in particular basecoats for automobile refinish paint systems. These coating materials can be single-component coating materials or else multicomponent coating materials.

The formulations of coating materials can be water-based or else based on organic solvents.

They generally comprise at least one polymer as binder, i.e. at least one of the following materials known per se: random, alternating and/or block-type, linear and/or branched and/or comb-type (co)polymer of ethylenically unsaturated monomers, or polyaddition resin and/or polycondensation resin. These polymers can be UV-curable. However, it is preferable that in conjunction with the coating materials providing a color and/or a special effect, they are heat-curable; this means that cross-linking can take place (formation of a coating film) via chemical reactions of reactive functional groups known per se, where the energy for activation of these chemical reactions can be provided by thermal energy. For this purpose it is also possible by way of example to use the cross-linking agents known per se. However, in every case these coating materials can at least to some extent be cured physically by virtue of the use of appropriate binders (i.e. the curing of a layer made of a coating material is (also) achieved via filming caused by loss of solvent from the coating material, where the interlinking within the coating takes place by way of formation of polymer molecule loops).

The coating materials moreover comprise at least one pigment which provides a color and/or a special effect. These pigments are numerous and widely available and do not require any more detailed explanation.

Other typical components of the coating material are the additives known per se, for example wetting and dispersing agents, emulsifiers, leveling aids, solubilizers, antifoams, stabilizers, including heat stabilizers, process stabilizers and UV and/or light stabilizers, deaerators, inhibitors, catalysts and/or flexibilizers.

For the purposes of the present invention it is preferable that the at least one coating material which provides a color and/or a special effect corresponds in respect of the perceived color and/or special effect to the original hue of the original paint system requiring refinish. Accordingly, it is possible to conceive of kits of the invention which comprise one or numerous markers (4A) that comprise a coating material which provides a color and/or a special effect and by way of which, after application to a surface, in each case the hue (i.e. the perceived color and/or perceived special effect) of an original color of an automobile is obtained. In particular in this context it is useful to equip a kit with coating materials by way of which it is possible during the refinish to replicate hues of typical automobiles marketed in large numbers. The great advantage here is that the coating materials which provide a color and/or a special effect and which are to be charged to the markers (4A) and to be used for the refinish can be formulated and produced centrally and uniformly. In particular, there is now no complicated, individual-case-related mixing and color matching in appropriate refinishing workshops. There is therefore likewise now no individualized matching of a hue to the actual hue of a vehicle after a number of months or years of use (effect of weathering). However, the overall effect of the uniform and precise matching of original hues is to achieve a color matching quality that is sufficient to meet the requirements placed upon cosmetic refinishing. This is in particular the case in relation to vehicles which have been in use for a comparatively short time, for example those arising in the context of de-fleet processes.

For the clearcoat material in the marker (B), the statements above are applicable in relation to formulation constituents fundamentally present. However, the clearcoat material is always a UV-curable coating material. Accordingly, the coating material has UV-curable components, i.e. in particular UV-curable oligomers and/or polymers as binders. Examples of appropriate binder components are the known unsaturated esters, epoxy resins, urethanes and/or siloxanes which by way of example have carbon-carbon double bonds in terminal and/or pendent groups. Appropriate groups are in particular acrylic and/or methacrylic groups. It is preferable that the at least one UV-curable oligomer and/or polymer is a urethane which additionally has acrylic and/or methacrylic groups (another term used being urethane (meth)acrylates). It is preferable that the UV-curable oligomers and/or polymers, in particular the urethane (meth)acrylates, are aliphatic. The groups having carbon-carbon double bonds are in principle stable. However, incident high-energy radiation, in this case UV radiation, if appropriate in combination with UV photoinitiators additionally used, can initiate, by way of free-radical formation, a reaction cascade that leads to a very high level of cross-linking and therefore hardening.

In this connection it is also possible to use known reactive diluents, i.e. generally monomeric compounds having functional groups having at least two carbon-carbon double bonds, which in principle serve as solvents but on irradiation with UV light are likewise involved in the curing and cross-linking processes described.

Because of their cross-linking chemistry and instability in the presence of water, these coating materials are generally water-free, i.e. based on organic solvents. These organic solvents are by way of example combinations of the reactive diluents described above, and other solvents which are inert to UV-irradiation and serve by way of example for viscosity adjustment. After application of the coating material and during or even before hardening and cross-linking, these materials are removed by evaporation processes from the film of coating material.

Because this is a clearcoat, it is, of course, entirely or very substantially free from pigments which provide a color and/or a special effect, preferably entirely free from said pigments. It comprises at most a quantity of pigments that does not affect the fundamental transparency of the layer produced from the material to an extent such that the layer of the material which provides a color and/or a special effect situated thereunder is no longer visible. However, it is possible that there is a very small extent of pigmentation present, by way of which a particular tinting effect is achieved (tinted clearcoat).

The UV-curable clearcoat material therefore preferably comprises at least one UV-curable oligomer and/or polymer as binder, at least one photoinitiator, and at least one organic solvent. It is further preferable that the material moreover comprises at least one UV stabilizer and/or light stabilizer which reduces the penetration of appropriate radiation onto coating material arranged under the clearcoat material and thus contributes to the stability of the refinish paint system.

The kit of the invention moreover comprises a means of hardening of the clearcoat material described above by irradiation with UV light. These means are obtainable commercially. In particular, they are familiar UV lamps or else LED lamps which also have UV light in the spectrum of the light that they emit. It is preferable that the UV light for curing is UV-A radiation.

It is preferable that the kit of the invention moreover comprises a means (6) which is intended for the removal of excess coating material which has been applied during the course of refinishing. This can be one of the means described above as component (3), where these also appear to be in principle suitable for the operation mentioned in the preceding sentence. However, it is also possible to use another means that is specifically intended for the removal of coating material on and at regions that have already completed refinish, and that differs from the means (3). In particular, this is abrasive paper with grit numbers in the range from P1500 to P3000, or else knives/blades. By way of these means (6) it is then possible to achieve particularly successful removal of material by abrasion or paring, i.e. removal of material by abrasion or paring without causing further damage to the refinished region.

The present invention also provides a process for the refinishing of automobile paint systems with the use of the refinishing kit of the invention. All of the preferred embodiments described above for the components to be used in the kit are, of course, also applicable in connection with the process of the invention.

The process begins with (i) application of the cleaner (1) to a damaged area requiring refinish in an automobile paint system.

This is followed by (ii) take-up, by way of the cleaning cloth (2), of the cleaner (1) applied and of any contamination present on the damaged area requiring refinish.

This is followed by (iii) by way of the means (3), roughening of the damaged area requiring refinish and mechanical removal of any loose coating material present in and/or at the damaged area.

This is followed by (iv A) by way of the marker (4A), application, to the damaged area requiring refinish, of coating material which provides a color and/or a special effect, and air-drying of the coating material applied. The application is achieved by pressing of the marker or of the tip of the marker onto the damaged area requiring refinish. The mechanism of transfer or application of the coating material to the surface requiring refinish has been fully described at an earlier stage above.

The coating material is then air-dried. This means evaporation of, or permitting evaporation of, organic solvents and/or water present in the coating material, mostly at ambient temperature (i.e. room temperature), for example from 15 to 35° C., for a period of by way of example from 0.5 to 30 min. Organic solvents and/or water present in the applied coating material therefore evaporate during the air-drying. Since the coating material is always still flowable directly after application and at the start of air-drying, it can flow during air-drying. Specifically, it is flowable by virtue of the organic solvents and/or water present, and can therefore flow to form a homogeneous, smooth coating film. At the same time, organic solvents and/or water progressively evaporate, and therefore the air-drying phase results in a comparatively smooth coating layer which comprises less water and/or solvent than the coating composition applied. However, the coating layer is not yet in ready-to-use condition after air-drying. Although it is by way of example no longer flowable, it is still soft, and may sometimes have been dried only to a small extent. However, it provides a surface suitable for overcoating with a clearcoat material. In particular, the coating layer has not yet been cured as described at a later stage below.

This is followed by (iv B) by way of the marker (4B), application of UV-curable clearcoat material to the applied coating material which provides a color and/or a special effect, and (v) by way of the means (5), hardening of the applied clearcoat material by irradiation with UV light.

Application of the clearcoat material is achieved by analogy with the process described above for the coating material which provides a color and/or special effect. The clearcoat material applied can then be air-dried in a manner similar to that in the process described above. However, this is followed by curing (chemical cross-linking) of the clearcoat material by way of the means (5).

This hardening can be achieved by way of example by brief operation of the means (5), in particular of the lamp, for example in the range from 0.5 to 5 minutes, where said lamp is held at a distance of about 5 to 30 centimeters above the applied clearcoat material.

The clearcoat material has then been cured; a cured clearcoat layer is therefore present.

Curing therefore means the conversion of a layer of coating material to the ready-to-use condition, i.e. to a condition in which the substrate equipped with the respective coating material can be subjected to correct use. A cured layer of coating material is therefore in particular no longer soft or tacky, but instead is a fully processed coating film, the properties of which, such as hardness or adhesion on the substrate, undergo no further substantial change even on further exposure to appropriate curing conditions.

During the curing described, the coating material which provides a color and/or special effect is also cured or at least converted to a condition that is dry to the extent that the overall result (i.e. including the clearcoat thereabove) is a fully refinished substrate which can be subjected to correct use, because the energy introduced via irradiation by the means (5) will, after conversion into heat, also contribute to the physical and/or chemical (thermal) curing of the coating material which provides a color and/or special effect. Insofar as the coating material which provides a color and/or special effect is also UV-curable, that property in itself obviously leads to curing of this material.

This is then followed, where appropriate, by the removal, already described above, of excess coating material by way of the means (6).

The kit of the invention and the process of the invention provide a possible method which on the one hand does not require the very time-consuming and expensive steps of expert refinishing, with high materials usage, but on the other hand ensures acceptable quality of the result of refinishing.

1. A refinishing kit for automobile paint systems, comprising:
(1) at least one cleaner for application to a damaged area requiring refinish in an automobile paint system;
(2) at least one cleaning cloth for take-up of the cleaner from (1) and of any contamination present on the damaged area requiring refinish;
(3) at least one means of roughening of the damaged area requiring refinish and of mechanical removal of loose coating material in and/or at the damaged area;
(4A) and (4B) at least two markers, respectively comprising:
(4.1) a reservoir with an opening;
(4.2) a valve which can be placed onto the opening of the reservoir from (4.1); thus closing the opening of the reservoir; and
(4.3) a marker tip,
where
the reservoir comprises a coating material,
the valve can be reversibly opened by exerting pressure, so that the coating material can be discharged from the reservoir,
there is connection between the marker tip and the valve, such that a pressure exerted on the marker tip is transmitted to the valve and the coating material can be conveyed by way of the opening of the valve into the marker tip, and
a design of the marker tip is such that the coating material conveyed into the marker tip can pass through the marker tip and can be transferred onto the damaged area requiring refinish,
where moreover the marker (4A) comprises a coating material which provides a color and/or a special effect, and the marker (4B) comprises a UV-curable clearcoat material;
and
(5) at least one means of hardening of the clearcoat material from (4.3) by irradiation with UV light.

2. The refinishing kit as claimed in claim 1, wherein emery paper and/or polishing sticks are used as means (3).

3. The refinishing kit as claimed in claim 1, wherein the marker tip (4.3) has been produced from foam material or felt material.

4. The refinishing kit as claimed in claim 1, wherein marker (4B) is composed of materials impermeable to UV light and/or has at least one layer which is impermeable to UV light and which ensures that the coating material present in the marker (4B) cannot be exposed to UV light.

5. The refinishing kit as claimed in claim 1, wherein marker (4A) comprises a coating material which provides a color and/or a special effect and by way of which, after application to a surface, a hue of an original color of an automobile is obtained.

6. The refinishing kit as claimed in claim 5, wherein the kit comprises at least five markers (4A) that respectively comprise a coating material which provides a color and/or a special effect and by way of which, after application to a surface, a hue of an original color of an automobile is obtained.

7. The refinishing kit as claimed in claim 1, wherein the clearcoat material comprises at least one UV-curable oligomer and/or polymer as binder, at least one photoinitiator and at least one organic solvent and at least one UV stabilizer and/or light stabilizer.

8. The refinishing kit as claimed in claim 1, wherein the kit moreover comprises at least one means (6) which differs from the respectively selected means (3) and which is intended for the removal of excess coating material which has been applied during the course of refinishing.

9. The refinishing kit as claimed in claim 1, wherein the components of the kit are stored within an individualized storage unit and are thus kept available for the use in the refinishing process.

10. A process for the refinishing of automobile paint systems with the use of the refinishing kit as claimed in claim 1, comprising the following steps in the stated sequence:
(i) application of the cleaner (1) to a damaged area requiring refinish in an automobile paint system,
(ii) take-up, by way of the cleaning cloth (2), of the cleaner (1) applied and of any contamination present on the damaged area requiring refinish,
(iii) by way of the means (3), roughening of the damaged area requiring refinish and mechanical removal of any loose coating material present in and/or at the damaged area,
(iv A) by way of the marker (4A), application, to the damaged area requiring refinish, of coating material which provides a color and/or a special effect, and air-drying of the coating material applied,
(iv B) by way of the marker (4B), application of UV-curable clearcoat material to the applied coating material which provides a color and/or a special effect,
and
(v) by way of the means (5), hardening of the applied clearcoat material by irradiation with UV light.

11. An automobile paint system which has been refinished by way of the process as claimed in claim 10.

12. The refinishing kit as claimed in claim 6, wherein the kit comprises at least ten markers (4A) that respectively comprise a coating material which provides a color and/or a special effect and by way of which, after application to a surface, a hue of an original color of an automobile is obtained.
